(19) United States
(12) Patent Application Publication
(10) Pub. No.: US 2017/0118771 A1
(43) Pub. Date: Apr. 27, 2017

(54) CSMA With Adaptive Carrier Sensing Threshold In LAA Networks

(71) Applicant: Telefonaktiebolaget LM Ericsson (publ), Stockholm (SE)

(72) Inventors: Muhammad KAZMI, Bromma (SE); Laetitia FALCONETTI, Solna (SE); Bruhtesfa GODANA, Stavanger (NO)

(21) Appl. No.: 15/031,997

(22) PCT Filed: Mar. 11, 2016
(86) PCT No.: PCT/SE2016/050203

§ 371 Date: Apr. 25, 2016

Related U.S. Application Data
(60) Provisional application No. 62/144,663, filed on Apr. 8, 2015.

(51) Int. Cl. H04W 74/08; H04W 16/14; H04L 5/00

(52) U.S. Cl. CPC H04W 74/0808; H04L 5/0041; H04L 5/001; H04W 16/14

(57) ABSTRACT

In one aspect, a device operating in a wireless communication network is configured to operate with at least a first carrier, or in carrier aggregation with the first carrier and a second carrier. The device dynamically determines a carrier sensing threshold for determining whether the first carrier is available for use by the device, based on channel information. The device also indicates an availability of the first carrier responsive to a CCA of the first carrier, based on the carrier sensing threshold. A CCA is performed based on the adaptive carrier sensing threshold.

### TECHNICAL FIELD

The present invention generally relates to wireless communication networks, and particularly relates to carrier aggregation involving unlicensed frequency bands.

### BACKGROUND

Long Term Evolution (LTE) specifications have been standardized, supporting Component Carrier (CC) bandwidths up to 20 MHz (which is the maximal LTE Rel-8 carrier bandwidth). LTE operation with wider bandwidth than 20 MHz is possible, using multiple CCs, appearing as a number of LTE carriers to an LTE terminal. A straightforward way to obtain this would be by means of Carrier Aggregation (CA). CA implies that an LTE Rel-10 terminal can receive multiple CC, where the CC have, or at least the possibility to have, the same structure as a Rel-8 carrier.

The LTE standard supports up to 5 aggregated carriers, where each carrier is limited, according to the 3GPP specifications, to have one of six bandwidths, namely 6, 15, 25, 50, 75 or 100 RB (corresponding to 1.4, 3, 5, 10, 15 and 20 MHz respectively). The number of aggregated CCs as well as the bandwidth of the individual CC may be different for uplink and downlink. A symmetric configuration refers to the case where the number of CCs in downlink and uplink is the same whereas an asymmetric configuration refers to the case that the number of CCs is different. It is important to note that the number of CCs configured in the network may be different from the number of CCs seen by a terminal. That is, a terminal may, for example, support more downlink CCs than uplink CCs, even though the network offers the same number of uplink and downlink CCs.

During initial access, an LTE CA-capable terminal behaves similarly to a terminal not capable of CA. Upon successful connection to the network, a terminal may, depending on its own capabilities and the network, be configured with additional CCs in the uplink (UL) and downlink (DL). This configuration is based on Resource Radio Control (RRC) signaling. Due to the heavy signaling and rather slow speed of RRC signaling, it is envisioned that a terminal may be configured with multiple CCs, even when not all of them are currently used. If a terminal is activated on multiple CCs, this would imply it has to monitor all DL CCs for PDCCH and PDSCH. This implies a wider receiver bandwidth, higher sampling rates, etc., resulting in high power consumption.

In CA, the terminal is configured with a primary CC (or cell or Serving cell), which is referred to as the Primary Cell or PCell. The PCell is particularly important, e.g., due to control signaling on this cell and UE monitoring of the radio quality on the PCell. A CA-capable terminal can, as explained above, also be configured with additional carriers (or cells or serving cells) which are referred to as Secondary Cells (SCells). Note that the terms terminal and UE may be used interchangeably throughout this document.

To further improve the performance of LTE systems, CA has been expanded to enable the use of LTE in an unlicensed spectrum. This operation is referred to as Licensed Assisted Access (LAA). As unlicensed spectrum may never match the qualities of licensed spectrum, the intention with LAA is to apply carrier aggregation and use a secondary carrier in an unlicensed band, while having a primary carrier in a licensed band. This will then ensure that the reliability associated with licensed carriers can be enjoyed for the primary carrier and only secondary carriers are used in unlicensed bands. CA using licensed and unlicensed carriers is shown, for example, in FIG. 1.

In order to transmit in unlicensed spectrum, which is free and shared by everyone, some regulations have to be followed. Most regulatory bodies, including Europe's ETSI, require networks operating in unlicensed spectrum to use a Carrier Sense Multiple Access (CSMA) protocol. This means that transmitters are required to listen to the presence of carriers in the channel before occupying the channel and transmitting for a particular duration. This is performed by detecting energy on that particular channel for a channel sensing duration. Hence, this protocol is also known as Listen-Before-Talk (LBT) protocol. The channel access mechanism of Wi-Fi is also based on CSMA.

Although LAA is not yet completely defined, it is known that LAA is required to use LBT protocol in order to be adopted as a global technology. ETSI's broadband radio access network (BRAN) defines different LBT protocols for frame based and load based systems. Although these LBT protocols have their differences, the general principle is the same. When a transmitter (an eNodeB or a UE) has data to transmit, it performs a Clear Channel Assessment (CCA) for a particular duration. This means that it determines whether the channel is free or occupied by measuring the energy on the medium for this CCA duration. If the channel is found to be free, the transmitter occupies the channel and transmits for a channel occupancy time, which can range from 1 ms to 10 ms. Since LAA will adopt the frame structure of LTE, this is equivalent to 1 to 10 subframes. If the channel is found to be occupied, on the other hand, the transmitter refrains from transmitting and waits until the channel becomes free. In order to determine whether the channel is occupied or not during a particular CCA duration, a transmitter measures the energy detected during the CCA duration and computes the corresponding power level. Then, the power level is compared against a carrier sensing threshold, which may be referred to as a CCA threshold. If the power level is above the carrier sensing threshold, the channel is considered to be occupied. If the power level is below the threshold, on the other hand, the channel is considered to be free. FIG. 2 illustrates LBT based channel access for LAA.

In ETSI's BRAN, it is stated that the threshold (TL) that should be used for CCA has to be less than or equal to the following value:

$$TL = - \frac{73 dBm}{MHz} + ( 23 - {P}_{H} ) \qquad ( 1 )$$

where, P_{H} is the EIRP (effective isotropic radiated power) in dBm. For a 20 MHz channel bandwidth and an EIRP of 23 dBm, the threshold reduces to:

TL=−60 dBm (2)

Hence, a threshold of −60 dBm or lower shall be used. For example, Wi-Fi uses a threshold of −62 dBm for energy detection over 20 MHz bandwidth. For CCA in LAA, a threshold satisfying this condition should be selected. For example, LAA can adopt the same threshold as Wi-Fi (−62 dBm) in order to have a fair share of the channel utilization.

### SUMMARY

It is recognized herein that there are several limitations when it comes to directly adopting a CSMA scheme for use with LTE networks. One of these limitations is using a fixed carrier sensing threshold. It is further recognized herein that using a fixed threshold makes coexistence challenging and leads to various problems depending on the value of the threshold. Embodiments of the present invention thus comprise apparatuses and methods that provide for dynamically determining a carrier sensing threshold. Dynamically determining a carrier sensing threshold means that the carrier sensing threshold is adaptive and can be set, adjusted or adapted by a node or UE immediately prior to and/or during LAA operations, for example. This is in contrast to adopting a fixed carrier sensing threshold. LAA is required to perform CSMA protocol (LBT) in order to operate in unlicensed spectrum. The design of LBT in LAA is important for the performance of LAA and other coexisting networks like Wi-Fi.

According to some embodiments, a method, in a device (e.g., network access node or UE) operating in a wireless communication network with at least a first carrier, includes dynamically determining a carrier sensing threshold for determining whether the first carrier is available for use by the device, based on channel information Channel information includes one or more performance related metrics or criteria related to current or past use of one or more channels on a targeted carrier or other carriers Channel information may include DL signal quality, UL signal quality, LBT success rate, channel sharing ratio, etc. The method also includes indicating an availability of the first carrier responsive to a CCA of the first carrier, based on the carrier sensing threshold.

The method may also include operating in carrier aggregation with a second carrier. The first carrier may be an unlicensed frequency band and the second carrier may be a licensed frequency band.

The method may also be implemented by devices, computer readable medium, computer program products and functional implementations.

According to some embodiments, a device operating in a wireless communication network configured to operate in carrier aggregation with a first carrier in a licensed frequency band and a second carrier in an unlicensed frequency band, includes a processing circuit configured to dynamically determine a carrier sensing threshold for determining whether the second carrier is available for use by the wireless device, based on channel information. The processing circuit is also configured to indicate an availability of the second carrier responsive to a CCA of the second carrier, based on the carrier sensing threshold.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a diagram illustrating carrier aggregation with licensed and unlicensed frequency bands.

FIG. 2 is a diagram illustrating LBT based channel access for LAA.

FIG. 3 is a block diagram of a network access node configured with a carrier sensing mechanism, according to some embodiments.

FIG. 4 is a block diagram of a user equipment configured with a carrier sensing mechanism, according to some embodiments.

FIG. 5 illustrates a method of determining a carrier sensing threshold, according to some embodiments.

FIG. 6 illustrates a scenario where both an LAA eNodeB and an LAA UE receive high interference from other transmissions like Wi-Fi access points or other LAA network nodes, according to some embodiments.

FIG. 7 illustrates a scenario where an LAA eNodeB receives less interference but an LAA UE receives high interference from other transmissions like Wi-Fi access points or other LAA network nodes, according to some embodiments.

FIG. 8 illustrates a scenario where an LAA eNodeB receives high interference but an LAA UE receives low interference from other transmissions like Wi-Fi access points or other LAA network nodes, according to some embodiments.

FIG. 9 illustrates a scenario where both an LAA eNodeB and an LAA UE receive low interference from other transmissions like Wi-Fi access points or other LAA network nodes, according to some embodiments.

FIG. 10 is a block diagram of a network access node configured with a carrier sensing mechanism, according to some embodiments.

FIG. 11 is a block diagram of a user equipment configured with a carrier sensing mechanism, according to some embodiments.

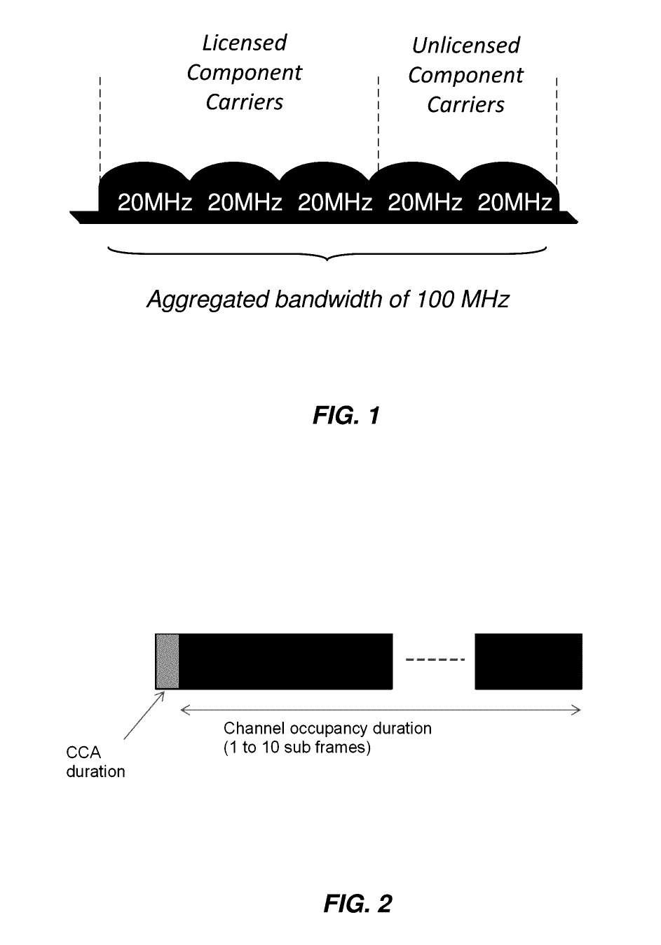

### DETAILED DESCRIPTION

There are several limitations when directly adopting a CSMA scheme for LTE networks. Using a fixed threshold makes coexistence challenging and leads to various problems, depending on the value of the threshold. For example, the preselected carrier sensing threshold can degrade the performance of LAA. There are two reasons a static threshold is bad for LAA performance On one hand, a very low LAA carrier sensing threshold results in a lower chance of using the channel, resulting in increased packet delay and decreased user throughput. On the other hand, a high LAA carrier sensing threshold increases the chance of simultaneous channel access with other technologies. This makes LAA nodes significantly susceptible to hidden node problems from other LAA nodes or from other transmissions like Wi-Fi. Hence, a high threshold can cause low user throughput due to hidden node issues.

A preselected carrier sensing threshold can cause bad performance for other coexisting networks. A higher carrier sensing threshold results in aggressive transmission from LAA. This prevents other transmitters nearby from occupying the channel, hence reducing their fair share of the channel Depending on the sensing threshold of the coexisting networks, their receivers will also be affected by hidden node problems caused by LAA.

Preselecting a carrier sensing threshold in between does not solve these issues. This is because it is not the absolute value of the threshold that matters. Rather, it is the value of the threshold in relation to the availability/absence and proximity of other interferers.

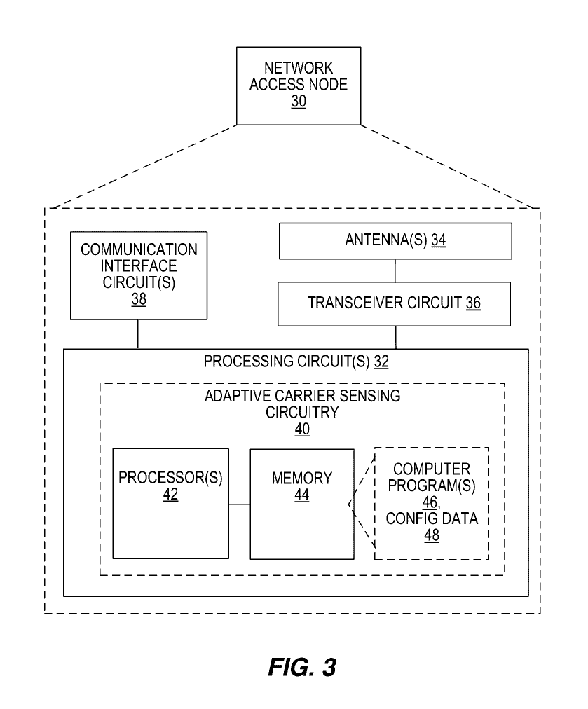

Embodiments of the present invention provide for dynamically determining carrier sensing thresholds. The methods described herein can be implemented by a device, such as a network access node. FIG. 3 illustrates a diagram of a network access node 30, according to some embodiments. The network node 30 facilitates communication between wireless terminals, or UEs, and the core network. The network access node 30 includes a communication interface circuit 38 that includes circuitry for communicating with other nodes in the core network, radio nodes, and/or other types of nodes in the network for the purposes of providing data and cellular communication services. The network access node 30 communicates with UEs via antennas 34 and a transceiver circuit 36. The transceiver circuit 36 may include transmitter circuits, receiver circuits, and associated control circuits that are collectively configured to transmit and receive signals according to a radio access technology, for the purposes of providing cellular communication services. According to various embodiments, cellular communication services may be operated according to any one or more of the 3GPP cellular standards, GSM, general packet radio service (GPRS), wideband code division multiple access (WCDMA), high-speed downlink packet access (HSDPA), LTE and LTE-Advanced.

The network access node 30 also includes one or more processing circuits 32 that are operatively associated with the communication interface circuit 38 or transceiver circuit 36. The network access node 30 uses the communication interface circuit 38 to communicate with network nodes and the transceiver 36 to communicate with UEs. For ease of discussion, the one or more processing circuits 32 are referred to hereafter as “the processing circuit 32.” The processing circuit 32 comprises one or more digital processors 42, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, the processing circuit 32 may comprise fixed circuitry, or programmable circuitry that is specially configured via the execution of program instructions implementing the functionality taught herein, or may comprise some mix of fixed and programmed circuitry. The processor 42 may be multi-core having two or more processor cores utilized for enhanced performance, reduced power consumption, and more efficient simultaneous processing of multiple tasks.

The processing circuit 32 also includes a memory 44. The memory 44, in some embodiments, stores one or more computer programs 46 and, optionally, configuration data 48. The memory 44 provides non-transitory storage for the computer program 46 and it may comprise one or more types of computer-readable media, such as disk storage, solid-state memory storage, or any mix thereof. By way of non-limiting example, the memory 44 comprises any one or more of SRAM, DRAM, EEPROM, and FLASH memory, which may be in the processing circuit 32 and/or separate from the processing circuit 32.

In general, the memory 44 comprises one or more types of computer-readable storage media providing non-transitory storage of the computer program 46 and any configuration data 48 used by the network access node 30. Here, “non-transitory” means permanent, semi-permanent, or at least temporarily persistent storage and encompasses both long-term storage in non-volatile memory and storage in working memory, e.g., for program execution.

In some embodiments, the processor 42 of the processing circuit 32 may execute a computer program 46 stored in the memory 44 that configures the processor 42 to operate in standalone mode. The processor may be configured to dynamically determine a carrier sensing threshold for determining whether a first carrier is available for use by the device (network access node 30), based on channel information. The processor 42 is also configured to indicate an availability of the first carrier responsive to a CCA of the first carrier, based on the carrier sensing threshold. This functionality may be performed by adaptive carrier sensing circuitry 20 in processing circuit 32.

In other embodiments, the processor 42 of the processing circuit 32 may execute a computer program 46 stored in the memory 44 that configures the processor 42 to operate in carrier aggregation with a first carrier and a second carrier. The first carrier may be a licensed frequency band and the second carrier may be an unlicensed frequency band. The processor is configured to dynamically determine a carrier sensing threshold for determining whether the second carrier is available for use by the device (network access node 30), based on channel information. The processor 42 is also configured to indicate an availability of the second carrier responsive to a CCA of the second carrier, based on the carrier sensing threshold. This functionality may also be performed by adaptive carrier sensing circuitry 40 in processing circuit 32.

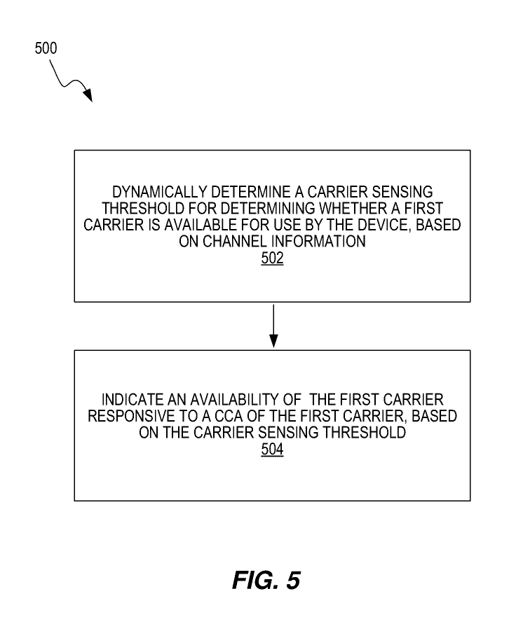

The processing circuit 32 of the network access node 30 is configured to perform a method, such as method 500 of FIG. 5. The method 500 includes dynamically determining a carrier sensing threshold for determining whether a first carrier is available for use by the device (network access node 30), based on channel information (block 502). The method 500 also includes indicating an availability of the first carrier responsive to a CCA of the first carrier, based on the carrier sensing threshold (block 504).

Rather than operating in a standalone mode, the method 500 may include operating in carrier aggregation with the first carrier and at least a second carrier. The first carrier may belong or correspond to an unlicensed frequency band and the second carrier may belong or correspond to a licensed frequency band.

The method 500 may also include indicating an availability of the first carrier responsive to carrier sensing, or detection, of the first carrier, based on the adaptive carrier sensing threshold. This may be an internal or external indication. This indication allows a node or UE to perform carrier sensing (e.g., CCA) with an adaptable carrier sensing threshold. The determining, indicating and performing may be iterative and occur as necessary to optimize use of the first carrier with respect to neighbor nodes and devices. Signals may be transmitted on the first carrier responsive to an indication of availability of the first carrier. In some cases, determining the carrier sensing threshold comprises determining the carrier sensing threshold based on a rate of previous CCA indications of availability of the first carrier. The first carrier may be an LAA carrier.

According to some embodiments, a method in an LAA node (e.g., network node for downlink, or DL, transmission or UE for uplink, or UL, transmission) includes dynamically or semi-statically adapting or adjusting an LBT detection threshold based on one or more performance related metrics or criteria (e.g., DL signal quality, LBT success rate, channel sharing ratio, etc.). The method also includes performing LBT based on the adapted LBT detection threshold, for detecting the availability of a channel on an unlicensed carrier.

Determining the carrier sensing threshold may comprise determining the carrier sensing threshold based on a quality of one or more signals previously detected on the first carrier. Methods to determine a carrier sensing threshold may be based on at least the signal quality measures at the UE and the network node (e.g., a network access node such as an eNodeB), if UL signal quality is available. These signal quality measurements can be used to estimate the level of interference experienced at least at the receiver (the UE receiver, in the case of DL transmissions) and the transmitter (the network access node or eNodeB, in the case of DL transmissions). By considering one or both of these types of metrics, the threshold determinations take into account both the performance of LAA and coexistence with other network nodes or with other networks using the unlicensed spectrum. In addition, threshold determination methods that consider LBT success rate and channel share fraction are also used separately or in combination with the signal quality related metrics.

The adaptive carrier sensing threshold determination scheme or mechanism can be pre-defined in a standard. If multiple adaptive carrier sensing threshold determination schemes are pre-defined, then the node or UE can be configured to use one or a combination of the schemes for dynamically determining the carrier sensing threshold.

The method 500 may include decreasing the carrier sensing threshold responsive to a determination that the signal quality is less than a target signal quality and increasing the carrier sensing threshold responsive to a determination that the signal quality is greater than the target signal quality.

In some embodiments, determining the carrier sensing threshold may include determining the carrier sensing threshold based on a channel sharing ratio of use of the first carrier by the device (node or UE) compared to use of the first carrier by other devices. This may include decreasing the carrier sensing threshold based on a channel sharing ratio reflecting less use of the first carrier by the other devices than by the device, or increasing the carrier sensing threshold based on a channel sharing ratio reflecting more use of the first carrier by the other devices than by the device.

The method 500 may also include determining the carrier sensing threshold based on a sensitivity of a receiver of the device (node or UE).

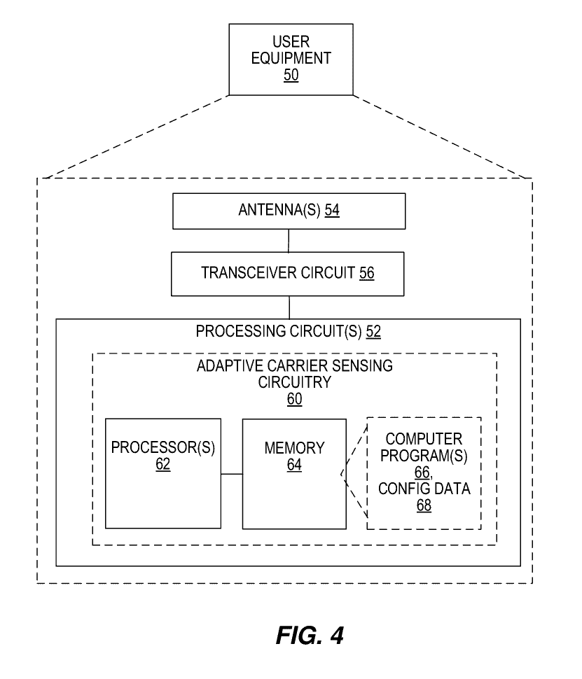

FIG. 4 illustrates a diagram of a device, now defined as a wireless device such as a user equipment 50, according to some embodiments. To ease explanation, the user equipment 50 may also be considered to represent any wireless device that may utilize CA or LAA in a network. The user equipment 50 communicates with a radio node or base station, such as network access node 30, via antennas 54 and a transceiver circuit 56. The transceiver circuit 56 may include transmitter circuits, receiver circuits, and associated control circuits that are collectively configured to transmit and receive signals according to a radio access technology, for the purposes of providing cellular communication services. According to various embodiments, cellular communication services may be operated according to any one or more of the 3GPP cellular standards, GSM, GPRS, WCDMA, HSDPA, LTE and LTE-Advanced.

The user equipment 50 also includes one or more processing circuits 52 that are operatively associated with the radio transceiver circuit 56. The processing circuit 52 comprises one or more digital processing circuits, e.g., one or more microprocessors, microcontrollers, DSPs, FPGAs, CPLDs, ASICs, or any mix thereof. More generally, the processing circuit 52 may comprise fixed circuitry, or programmable circuitry that is specially adapted via the execution of program instructions implementing the functionality taught herein, or may comprise some mix of fixed and programmed circuitry. The processing circuit 52 may be multi-core.

The processing circuit 52 also includes a memory 64. The memory 64, in some embodiments, stores one or more computer programs 66 and, optionally, configuration data 68. The memory 64 provides non-transitory storage for the computer program 66 and it may comprise one or more types of computer-readable media, such as disk storage, solid-state memory storage, or any mix thereof. By way of non-limiting example, the memory 64 comprises any one or more of SRAM, DRAM, EEPROM, and FLASH memory, which may be in the processing circuit 52 and/or separate from processing circuit 52. In general, the memory 64 comprises one or more types of computer-readable storage media providing non-transitory storage of the computer program 66 and any configuration data 68 used by the user equipment 50.

In some embodiments, the processor 62 of the processing circuit 52 may execute a computer program 66 stored in the memory 64 that configures the processor 62 to operate in standalone mode. The processor 62 is configured to dynamically determine a carrier sensing threshold for determining whether a first carrier is available for use by the device (user equipment 50), based on channel information. The processor 62 is also configured to indicate an availability of the first carrier responsive to a CCA of the first carrier, based on the carrier sensing threshold. This functionality may be performed by adaptive carrier sensing circuitry 60 in processing circuit 52.

In other embodiments, the processor 62 of the processing circuit 52 may execute a computer program 66 stored in the memory 64 that configures the processor 62 to operate in carrier aggregation with a first carrier and a second carrier. The first carrier may be a licensed frequency band and the second carrier may be an unlicensed frequency band. The processor 62 is configured to dynamically determine a carrier sensing threshold for determining whether the second carrier is available for use by the device, based on channel information. The processor 62 is also configured to indicate an availability of the second carrier responsive to a CCA of the second carrier, based on the carrier sensing threshold. This functionality may be performed by adaptive carrier sensing circuitry 60 in processing circuit 52.

According to some embodiments, the processing circuit 52 of the user equipment 50 is configured to perform a method, such as method 500 of FIG. 5, which was earlier described for the case where the device was a network access node 30.

In the descriptions of some embodiments, the non-limiting term UE is used. The UE herein can be any type of wireless device capable of communicating with network node or another UE over radio signals. The UE may also be radio communication device, target device, device to device (D2D) UE, machine type UE or UE capable of machine to machine communication (M2M), a sensor equipped with UE, PDA (personal digital assistant), Tablet, mobile terminals, smart phone, laptop embedded equipped (LEE), laptop mounted equipment (LME), USB dongles, Customer Premises Equipment (CPE) etc.

In the descriptions of some embodiments, the network access node 30 may be referred to as a node, network node or a radio network node. The network access node 30 can be any kind of network access node that may include a base station, radio base station, base transceiver station, evolved Node B (eNodeB), Node B, relay node, access point, wireless access point, radio access point, UltraDense Network (UDN)/Software Defined Network (SDN) radio access node, Remote Radio Unit (RRU), Remote Radio Head (RRH), etc. It may also include, in some cases, Operations Support System (OSS), Operations and Maintenance (O&M), Self-Organizing Network (SON), positioning node, Evolved Serving Mobile Location Center (E-SMLC), a centralized controller, a core network node, Mobility Management Entity (MME), base station controller, or network controller.

The network access node 30 and/or the UE 50 may be configured to determine a carrier sensing threshold, which may be considered an adaptive carrier sensing threshold. Determining the carrier sensing threshold includes generating a first carrier sensing threshold and/or adapting the carrier sensing threshold. The highest sensing carrier sensing threshold that can be used according to ETSI regulation is given by −73 dBm/MHz+(23−P_{H}). This may be denoted as a threshold by TH_{high}. The lowest carrier sensing threshold that can be used by LAA is determined by several factors including receiver sensitivity, minimum expected performance, etc. For example, the lowest carrier sensing threshold should be sufficiently higher than the noise sensitivity of the LAA receiver to avoid false alarm cases (incorrectly detecting that the channel is busy while it is free). The lowest carrier sensing threshold is represented by TH_{low}.

According to some embodiments, determining the carrier sensing threshold for LAA works as follows. At the beginning, the carrier sensing threshold is set to the lowest, TH_{low}. Then, the carrier sensing threshold TH is increased or decreased by a fraction α as follows, where −1≦α≦1:

TH=TH+ [symbol] (TH_{high}−TH_{low}) (3)

However, the carrier sensing threshold should be in the interval [TH_{low},TH_{high}]. Hence, it is bounded by these extreme values to ensure it is in this range,

TH=min(max(TH+ [symbol] (TH_{high}−TH_{low}), TH_{low}), TH_{high}) (4)

Some embodiments are described as determining the carrier sensing threshold for LBT for downlink transmission at the network access node 30 (e.g., eNodeB) based on one or more metrics. In this case, the network access node 30 would sense channels on an unlicensed carrier using the LBT principle in order to decide whether or not to transmit in the DL in the cell operating on that unlicensed carrier.

The same principles of determining the carrier sensing threshold disclosed in these embodiments can also be applied to determine the UE's carrier sensing threshold for uplink transmission. In this case, the UE 50 would try to sense signals on the channel on an unlicensed carrier (perform carrier sensing or CCA) using the LBT principle in order to decide whether or not to transmit in the UL in the serving cell operating on that unlicensed carrier.

In this scenario, it is assumed that the UE 50 is served by one serving cell, which in turn is served or managed by a network access node 30. This is an example of single carrier operation of the UE 50. In this case, the determination of the carrier sensing threshold is based on signal quality measurements typically performed by the network access node 30. The network access node 30 then also uses the adaptive carrier sensing threshold for performing the LBT to detect the availability of the channel on the unlicensed carrier.

A typical scenario involves CA operation of the UE 50, which is served by at least a PCell and one or more secondary serving cells (SCells). The PCell is served or managed by a second network access node and one or more SCells are served or managed by at least one network access node. Typically, the PCell operates on a licensed carrier whereas at least one SCell operates on an unlicensed carrier. In some embodiments, the network access node 30 and the second network access node are the same. For example, PCell and SCells are operated by the same eNB or in the same node or in the co-sited nodes. In this case, the carrier sensing threshold is determined based on signal quality measurements is typically performed by the network access node 30, i.e., the one that uses it for carrier sensing or CCA of the unlicensed carrier. However, this can also be performed by the second network access node, i.e., by the PCell and sent to the SCell. The network access node 30 serving SCell then also uses the adaptive carrier sensing threshold for performing the LBT on the SCell to detect the availability of the channel on the unlicensed carrier.

In CA operation, if multiple serving cells (e.g., two or more SCells) use unlicensed spectrum then each serving cell may independently apply one or a combination of criteria or mechanisms for determining the carrier sensing threshold for the LBT operation.

Various schemes are described for determining the carrier sensing threshold to be used for the CCA or LBT operation in the network access node 30 or in the UE 50 served by the network access node 30 operating in an unlicensed carrier. The dynamic determination of the adaptive carrier sensing threshold may be based on downlink and uplink signal quality, LBT success rate, current and previous indications of availability, a channel sharing ratio, or any combination of above.

Each of the above schemes or their combination dynamically determines the carrier sensing threshold based on one or more performance related metrics or criteria (e.g., DL signal quality, UL signal quality, LBT success rate, channel sharing ratio, etc.). The performance metric can be directly related to UE performance such as the downlink reception quality or UL reception quality at the network access node or it can be implicitly related to the UE performance or even to the overall system performance (e.g., LBT success rate, channel sharing ratio, etc.) or any combination thereof.

Any of the above schemes can be pre-defined in the standard or can also be implementation specific. If multiple schemes are supported by a node (e.g., first network node 30 and/or UE 50), then the node can be configured with one or combination of the schemes for dynamically determining the carrier sensing threshold for CCA as described herein.

After determining the carrier sensing threshold based on one or a combination of schemes, the network access node 30 and/or the UE 50 use the determined adaptive carrier sensing threshold for performing CCA, e.g., an LBT operation. If the LBT is successful on a channel operating in an unlicensed carrier, then the node transmits signals on that unlicensed carrier, e.g., network access node 30 transmits DL signals to one or more UEs 50 on that unlicensed carrier.

The node may also be configured with one or more parameters associated with the selected scheme (e.g., signal quality threshold, etc.) by another network node and/or one or more said parameters may be pre-defined and/or one or more said parameters may be implementation specific.

### Determining the Carrier Sensing Threshold Based on Downlink and Uplink Signal Quality

In some embodiments, the carrier sensing threshold is determined at the network access node 30 (e.g., eNodeB) based on at least one or more downlink signal quality measurements and also one or more uplink signal quality measurements in case the latter ones are also available as elaborated below.

Regarding the obtaining of DL signal quality measurements, when a network access node 30 gets the channel and transmits in the downlink, the UE 50 acquires information on the received downlink signal and, based on these signals, performs measurement on the downlink signal quality, denoted by SQUE. This information containing the signal quality measurement results can be sent via an uplink feedback channel directly to the network access node 30 (e.g., the transmitter (eNodeB)) or via another network node such as a second network access node (e.g., PCell). Typically, the UE 50 may send the measurement results to a serving cell that also has an uplink, e.g., PCell, PSCell or a SCell with uplink. Examples of DL signal quality measurements are Signal-to-Noise Ratio (SNR), Signal-to-Interference-plus-Noise Ratio (SINR), Channel State Information (CSI) including Channel Quality Indicator (CQI), Reference Signal Received Quality (RSRQ), Bit Error Rate (BER), Block Error Rate (BLER), Frame Error Rate (FER), etc.

Typically, several UEs 50 are served by the network access node 30 in the downlink. In this case, an equivalent or composite or combined downlink received signal quality SQUE, can be obtained or estimated or determined or derived by the network based on the plurality of the DL signal quality measurement results reported by plurality of UEs 50 served by the network access node 30. For example, the composite value of SQUE can be obtained or estimated or determined or derived by using a suitable function. Examples of function are average, maximum, minimum, Xth percentile, median etc. A general expression for obtaining such composite value is expressed by (5) below:

SQ_{UE}=f(SQ_{UE1}, SQ_{UE2}, . . . , SQ_{UE N}) (5)

where SQ_{UE1}, SQ_{UE2}, . . . , SQ_{UE}_{_}_{N} are the DL signal quality measurements performed by UE₁, UE₂, . . . , UE_{N} respectively on the DL signals transmitted by the first network node.

In the case of CA with DL only SCell(s), a second network access node (e.g., one serving PCell on licensed carrier) receiving the measurement results from the UE may send them to a serving cell, which determines the carrier sensing threshold based on UL and DL signal quality measurements. The network access node 30 (e.g., PCell) may also obtain the composite DL measurement using a function and send the composite value to the serving cell, which determines the carrier sensing threshold. The serving cell (e.g., SCell) may obtain, estimate, determine or derive the composite value in case this is not done by the second network access node (e.g., PCell) receiving measurements from the UE 50. For example, the results may be sent by the second network access node to the first network access node 30 serving or managing SCell via internal or implementation specific interface or via a standardized interface like X2 in LTE.

As for obtaining UL signal quality measurements, when the UE 50 gets an uplink grant and unoccupied channel, the UE 50 transmits signal in the uplink during which the network access node 30 can use these received signals for performing one or more uplink signal quality measurements, denoted as SQ_{eNB}. Examples of these UL signal quality measurements are SINR, CQI, BLER, FER, BER, or other similar measurements. Typically, there will be several receivers (UEs) 50 served by the network access node 30 in the downlink. In this case, an equivalent or composite or combined uplink received signal quality SQ_{eNB}, can be obtained by the network by taking into account the plurality of the signal quality measurement results of the signals transmitted by a plurality of UEs 50 served by the network access node 30. For example, the composite value of SQ_{eNB} can be obtained, estimated, determined or derived by using a suitable function. Examples of such function are average, maximum, minimum, Xth percentile, median etc. A general expression for obtaining such composite value is expressed by (6) below:

SQ_{eNB}=f(SQ_{eNB}_{_}_{E1}, SQ_{eNB}_{_}_{UE2}, . . . , SQ_{eNB}_{_}_{UE}_{_}_{N}) (6)

where are SQ_{eNB}_{_}_{E1}, SQ_{eNB}_{_}_{UE2}, . . . , SQ_{eNB}_{_}_{UE}_{_}_{N} are the signal quality measurements performed by the first network node on signals transmitted by UE₁, UE₂, . . . , UE_{N} respectively.

In this embodiment, only one LAA UE is considered for the sake of illustration. However, the embodiments are applicable for any number of UEs 50 operating under or served by the same network access node 30 (e.g., same serving cell such as SCell) by using expressions (5) and (6) for obtaining a composite signal quality measure.

As for the unavailability of UL signal quality measurements, if there is only DL transmissions and no UL transmissions in the serving cell, the network access node 30 cannot perform any uplink signal quality measurements. In this case, only DL signal quality measurements or their composite value can be used for determining the carrier sensing threshold for performing the carrier sensing. A few examples of such scenarios where there is no UL transmission are elaborated on below.

One example includes a scenario where the serving cell is only in the DL only serving cell, supplemental DL (SDL) serving cell, DL SCell in CA, etc. In this case, the network access node 30 may use only the DL signal quality measurements or their composite value for determining the carrier sensing threshold as described further below.

Another scenario is when there is no or negligible uplink traffic or very infrequent UL traffic in the serving cell and thus the network access node 30 can very occasionally perform UL signal quality, or the UL signal quality measurement is not sufficiently accurate or reliable. For example, the UL signal quality measurement is associated with a large error compared to the true value. In this case, the use of insufficient or unreliable UL signal quality measurement results/statistics may reliably or inaccurately determine the carrier sensing threshold. As an example, the network access node 30 may consider an UL signal quality measurement unreliable provided that the network access node 30 cannot obtain two or more samples of UL signals within a certain measurement time period, e.g., 100 ms.

Some embodiments or scenarios for determining a carrier sensing threshold are described. Assume that the signal quality measurements (i.e., UL signal quality measurements performed by the network access node's 30, e.g., eNodeB, and DL signal quality measurements obtained from one or more UEs 50) are deemed to be low when they are less than the target signal quality values denoted by T_{eNB} and T_{UE} respectively. Here, four scenarios are considered based on the eNodeB and UE signal quality ranges as described in the next sub-section.

By comparing the composite UL signal quality measured or estimated by the network access node 30 (if the UL quality is available or possible) and at least the composite DL signal quality measured or estimated by one or more UEs 50 to their respective target signal quality thresholds T_{eNB} and T_{UE}, the carrier sensing threshold can be determined. This adaptation is summarized in the following embodiments. 1) If SQ_{UE}<T_{UE}, SQ_{eNB}<T_{eNB}, decrease the carrier sensing threshold. 2) If SQ_{UE}<T_{UE}, SQ_{eNB}≧T_{eNB}, decrease or increase the carrier sensing threshold based on the relative values of the signal qualities as compared to the target signal quality thresholds. 3) If SQ_{UE}≧T_{UE}, SQ_{eNB}<T_{eNB}, decrease or increase the carrier sensing threshold based on the relative values of the signal qualities as compared to the target signal quality thresholds. 4) If SQ_{UE}≧T_{UE}, SQ_{eNB}≧T_{eNB}, increase the carrier sensing threshold aggressively.

Where, SQ_{UE} and SQ_{eNB} can be composite values obtained using a suitable function as described earlier in equations (5) and (6).

An example of a rule for determining the carrier sensing threshold in these four scenarios can be given by the following equation (7):

[symbol]

_{SQ}=w_{eNB} (SQ_{eNB}/T_{eNB}−1)+w_{UE} (SQ_{UE}/T_{UE}−1) (7)

where, w_{eNB} and w_{UE} are weights given to carrier sensing threshold determination by the eNodeB and UE signal qualities respectively. By default, or as a typical implementation, both of these weights can be set to 0.5. When w_{eNB}>w_{UE}, this means the signal quality at the eNodeB (transmitter) is weighted more than the signal quality at the receiver. More consideration is given to transmitters sharing the channel than their own performance. Hence, a higher value of WeNB results in more altruistic or considerate LAA, while a higher value of w_{UE} results in more egoistic LAA.

If UL signal quality (SQ_{eNB}) is not available (e.g., if serving cell is only DL) then only SQ_{UE} is compared with its respective TUE for determining the carrier sensing threshold. In this case, the values of w_{eNB} and w_{UE} can be set to 0 and 1 respectively. These scenarios are further described as follows.

Scenario 1 (SQ_{UE}<T_{UE}, SQ_{eNB}<T_{eNB})

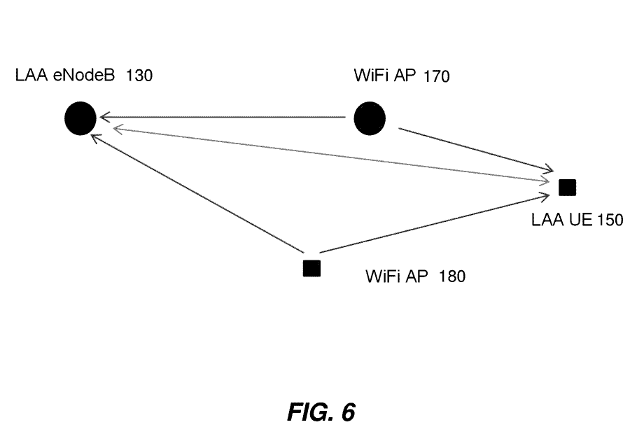

This is the case when the signal quality measurements at both the LAA network access node 30 and the UE 50 are low as shown by LAA eNodeB 130 and LAA UE 150 in FIG. 6. In FIGS. 6-9, the line between LAA eNodeB 130 and LAA UE 150 indicates an LAA signal and the lines from Wi-Fi Access Points 170 and 180 indicate possible interference from other transmitters. When the LAA UE 150 receives high interference (SQ_{UE}<T₂), it is an indication that the UE 150 is highly likely to be in a hidden node region. Being in a hidden node region means that when the LAA eNodeB 130 performs LBT, it is less likely to hear the transmissions from the interferers since they are not very close to the LAA eNodeB 130. Therefore, both the LAA eNodeB 130 and the Wi-Fi transmitters 170 and 180 transmit at the same time. In a sense, the LAA eNodeB 130 and the Wi-Fi transmitters 170 and 180 are “hidden” from each other, but both are heard at the LAA UE 150. Hence, the LAA UE 150 is in a hidden node region, where interference is as dominant as the useful signal, which results in low SINR at the LAA UE 150.

When the LAA UE 150 receives high interference (SQ_{UE}<T₂), the LAA eNodeB 130 can decrease its carrier sensing threshold in order to try to make sure that its LAA UE 150 receives transmissions from the serving cell without a nearby interferer transmitting simultaneously. Since the LAA eNodeB's 130 measured UL signal quality is also below the target signal quality threshold (SQ_{eNB}<T_{eNB}) in this scenario, this means that there are other interfering transmitters (e.g., UEs served by one or more neighboring network nodes (third network nodes) using the same channel) around or in the vicinity of the LAA eNodeB 130. In this case, the LAA eNodeB 130 may decrease its carrier sensing threshold to ensure coexistence with other technologies sharing the spectrum, i.e., the same unlicensed carrier. Hence, there can be two reasons for reducing the carrier sensing threshold in this example. In this case, the carrier sensing threshold can be decreased according to equation (4) and (7) above or using a moderate value of α=−0.5.

Scenario 2 (SQ_{UE}<T_{UE}, SQ_{eNB}≧T_{eNB})

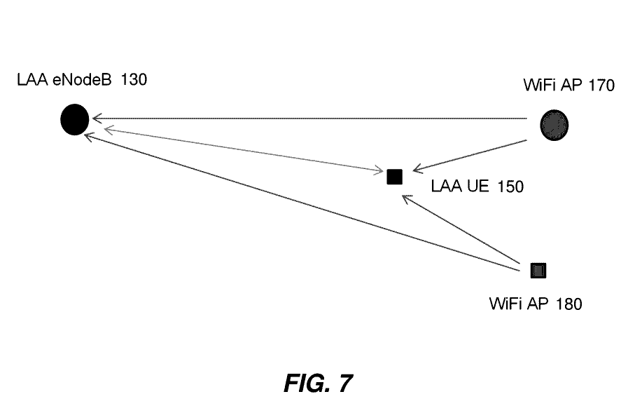

This is a case when the signal quality measured at the UE 50 is below a target signal quality threshold, but the signal quality measured at the network access node 30 is high (i.e., above or equal to a threshold), as demonstrated in FIG. 7. For example, the LAA UE 150 is in a high interference region so the LAA eNodeB 130 may decrease its carrier sensing threshold to safeguard its LAA UE 150 from interference. On the other hand, the LAA eNodeB 130 receives low interference (no interferer is nearby). As a result, coexistence between the LAA eNodeB 130 and other network nodes (third network nodes) using the same unlicensed carrier is not a problem. Therefore, in this scenario, the LAA eNodeB 130 can afford to be a little more aggressive. The carrier sensing threshold can be decreased slightly, for example, using α=−0.25 or decrease or increase depending on the value of a in equation (7) above.

Scenario 3 (SQ_{UE}≧T_{UE}, SQ_{eNB}<T_{eNB})

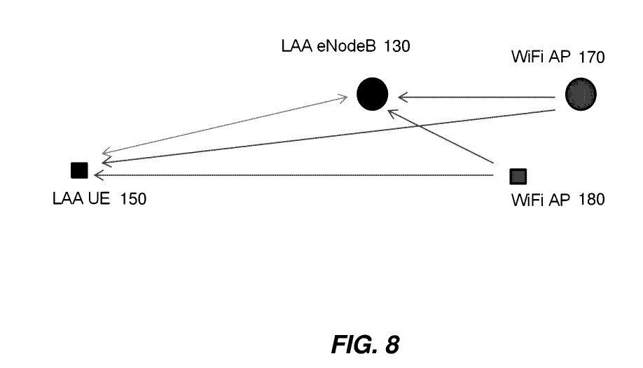

In the scenario illustrated by FIG. 8, the carrier sensing threshold is increased aggressively from the LAA UE's 150 perspective. However, increasing the carrier sensing threshold is not good from a coexistence perspective as there can be other transmitters sharing the channel and located nearby the LAA eNodeB 130, which will be prevented from transmitting. This means that it is more appropriate for the LAA eNodeB 130 to be considerate of the interferers nearby causing its low channel quality. Here, increasing the threshold is a tradeoff between the eNodeB's 130 own performance and coexistence with other network nodes, e.g., other LAA network nodes, WLAN access points, etc. Therefore, in this case, it is determined that the current carrier sensing threshold is to be maintained or unchanged. In some cases, the equations (4) and (7) can be used to increase or decrease the carrier sensing threshold only slightly.

Scenario 4 (SQ_{UE}≧T_{UE}, SQ_{eNB}≧T_{eNB})

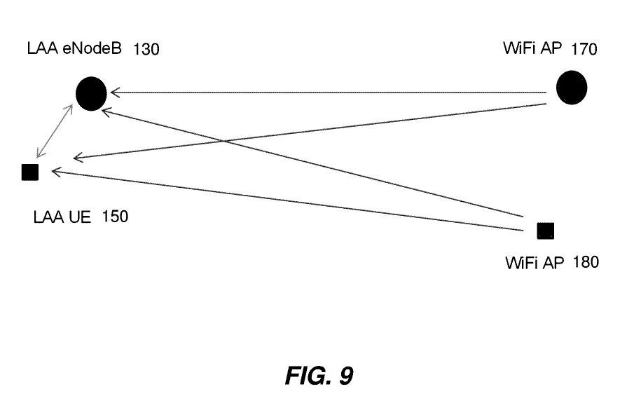

In the scenario illustrated by FIG. 9, the LAA UE 150 is in a low interference area (no hidden node issue and the LAA UE 150 is far from other network nodes using the same unlicensed carrier). Hence, downlink performance will not be affected even though the LAA eNodeB 130 occupies the channel aggressively by using a high carrier sensing threshold. Moreover, the LAA eNodeB 130 is far from other transmitters from the perspective of coexistence with these other network nodes. Therefore, a good strategy may be to increase the carrier sensing threshold in order to grab the channel on the unlicensed carrier more often, for example, by using α=0.5 or by using the equations (7) and (4) above.

### Determining the Carrier Sensing Threshold Based on CCA Success Rate

As discussed above, when an LAA node (e.g., first network node 30 or a UE 50 using an unlicensed carrier) has data to transmit, it performs CCA. This means that it measures the received power corresponding to the energy detected on the channel during a time period and compares it with a threshold. There are two possible outcomes, either a channel is found to be free and the node occupies the channel for one or several sub frames or the channel is found to be occupied. In the latter case, the LAA node tries CCA again at the next available transmission opportunity.

In some embodiments, the LAA carrier sensing threshold is determined based on a success rate of CCA, or a rate or percentage representing when the carrier is determined to be available via CCA. Until the current time, the number of CCA trials (number of times the node performs a CCA procedure) is represented by N. Out of these N trials, the node 30 or UE 50 has found the channel to be free M times. Hence, the CCA success rate can be defined as M/N. If the success rate is too low then the node 30 or UE 50 may consider increasing the carrier sensing threshold, i.e., making it more aggressive. If the success rate is too high on the other hand, then the carrier sensing threshold can be decreased, i.e., making it gentler. The success rate can be deemed to be low or high by comparing it to an expected success rate denoted by Sᵣ. For example, two nodes such as the network access node 30 and the third network nodes (e.g., two eNodeBs) sharing a channel may expect a ratio of 0.5. An example for determining the carrier sensing threshold based on success rate can be the following:

[symbol]

_{Sr}=1−(M/N)/Sᵣ (8)

In another aspect of this embodiment, this success rate based determination can be used if there is no information on the downlink or uplink channel or signal quality measurements (e.g., SINR as described earlier).

### Determining the Carrier Sensing Threshold Based on Channel Share Ratio

In some embodiments, the LAA carrier sensing threshold is determined based on a channel sharing ratio (channel or carrier occupancy ratio). When an LAA node (e.g., LAA eNodeB 130, LAA UE 150, etc.) finds the channel to be free, it occupies it for 1-10 subframes. When the channel is occupied, the LAA eNodeB 30 is not successful in that subframe and tries again at a later time. Until the current time, the total number of subframes during which an LAA node transmits (after finding the channel to be free or available) is represented by X. On the other hand, the total number of sub frames during which the channel is found to be occupied is represented by Y. Then, the fraction of time the node gets a share of the channel can be given by:

X/(X+Y) (10)

If the node is getting a low share of the channel (e.g., below 0.2), then this scarcity can be corrected or compensated by increasing the carrier sensing threshold for performing the CCA. On the other hand, if the node is getting very high share (e.g., above 0.6), then this abundance can be adjusted by decreasing the carrier sensing threshold used for the carrier sensing operation. Hence, the carrier sensing threshold can be adapted for example by using α as follows:

[symbol]

_{R}=1−(X/(X+Y))/R (11)

where R is a target channel sharing ratio. Depending on the deployment, an operator can set the average fraction of airtime R that a node (e.g., network access node 30) is allowed to use the carrier.

### Determining the Carrier Sensing Threshold Based on a Combination of Criteria

According to some embodiments, the node 30 or UE 50 uses any two or more criteria described earlier to determine the carrier sensing threshold for the CCA operation. This is explained with several examples of a combination of signal quality and success rate to determine the carrier sensing threshold.

In this scheme, if DL or UL channel or signal quality measurements or related information is available, then the network access node 30 may combine the success rate based determination with the signal quality based determination. To be more precise, this scheme can be combined with a signal quality determination as follows.

If scenario 1 (SQ_{UE}<T_{UE}, SQ_{eNB}<T_{eNB}) happens and the CCA success rate is below a success rate threshold, then this is an indication that increasing the carrier sensing threshold for CCA to improve a success rate will not be eventually useful for LAA since the UE is in a high interference area. So, it may be better for the node (e.g., network access node 30) to determine the carrier sensing threshold for carrier sensing based on signal quality only.

If scenario 4 (SQ_{UE}≧T_{UE}, SQ_{eNB}≧T_{eNB}) happens and the CCA success rate is above or equal to a success rate threshold (i.e., CCA success rate is high), then it may not be necessary for the network access node 30 to decrease a success rate by decreasing the carrier sensing threshold for CCA since the network access node 30 is likely to be alone or surrounded by very few or sparse other nodes in its sensing region.

In general, there can be several ways to determine the composite carrier sensing threshold parameter α, from the signal quality parameter obtained in the embodiments described above for as_{Q} and the parameter based on CCA success rate, α_{Sr}. One example of deriving or estimating the composite carrier sensing threshold is by computing α as follows:

[symbol]

=w_{SQ} [symbol] _{SQ}+w_{Sr} [symbol] _{Sr} (9)

where, w_{SQ} and w_{Sr} are the weights given to signal quality based and success rate based determinations respectively. In the case of scenarios 1 and 4, w_{SQ}=1 and w_{Sr}=0 can be used so that the carrier sensing threshold is determined entirely based on signal quality. In other scenarios, both weights can be set to 0.5.

### Combination of Signal Quality and Channel Ratio to Determine the Carrier Sensing Threshold

In this combined scheme the channel ratio based determination can also be combined with the signal quality based determination. This is described with the following examples.

If scenario 1 (SQ_{UE}<T_{UE}, SQ_{eNB}<T_{eNB}) happens and the channel sharing ratio is below a channel sharing threshold, then it may be beneficial for the network access node 30 or UE 50 to at least determine the carrier sensing threshold for CCA based on signal quality only. In this case, the network access node 30 or UE 50 in each step may also decrease the carrier sensing threshold with an amount larger than the one used for determination based only on the signal quality, e.g., by 4 dB instead of usual 2 dB.

If scenario 4 (SQ_{UE}≧T_{UE}, SQ_{eNB}≧T_{eNB}) happens and the channel sharing ratio is equal to or higher than a channel sharing threshold, then it may not be necessary for the node 30 or UE 50 to decrease the channel sharing ratio by decreasing the carrier sensing threshold for CCA since the node 30 or UE 50 is likely to be alone or surrounded by very few or sparse other nodes in its sensing region.

If scenario 4 (SQ_{UE}≧T_{UE}, SQ_{eNB}≧T_{eNB}) happens and the channel sharing ratio is below a channel sharing threshold then the node 30 or UE 50 may increase the channel sharing ratio by decreasing the carrier sensing threshold for a CCA operation. The reduction of the carrier sensing threshold can be done by an amount smaller than usually used, e.g., by 0.5 or 1 dB instead of 2 or 3 dB.

Multiple schemes or their combinations as described herein and can be pre-defined in a standard. However, a node 30 or a UE 50 may use one or any combination of the pre-defined schemes for an adaptive determination or adjustment of the carrier sensing threshold. For example, a node 30 or a UE 50 may be configured to use one of the pre-defined schemes or their combination for determination of the carrier sensing threshold. The step of selecting between the pre-defined schemes can be based on one or more criteria or conditions.

The node 30 or the UE 50 that uses a particular scheme for determining the carrier sensing threshold may be configured to do so by a second network node (e.g., by PCell) or by another network node (e.g., core network node). In yet another example, the first network node 30 or the UE 50 may autonomously select between different schemes or their combinations based on one or more criteria or conditions.

Examples of criteria or conditions that can be used for selecting between the schemes include a capability associated with carrier sensing threshold determination schemes. A node may not be capable of using all the schemes for the determination of the carrier sensing threshold. Therefore, the node is configured only with one of the schemes or their combination which are supported by the node.

Another example involves a reliability of signal quality measurements. If signal quality measurements are unreliable, such as incorporating large inaccuracy or error, then the network access node 30 or the UE 50 may use the scheme that determines the carrier sensing threshold based on schemes that use CCA success rate and/or channel sharing ratio.

A further example involves an availability of signal quality measurements. If signal quality measurements are reliable, but are not regularly available, then the network access node 30 or the UE 50 may use the scheme that determines the carrier sensing threshold based on schemes that use CCA success rate and/or channel sharing ratio. However, if the signal quality measurements are reliable and also regularly available, then the network access node 50 or the UE 50 may also use the scheme that determines the carrier sensing threshold based on signal quality measurements.

A scheme to determine the carrier sensing threshold may be based on a certain target performance metric, such as a desired CCA success rate or channel sharing ratio. For example, if the target or the aim is to ensure that a certain level of channel sharing is achieved within a certain time period, then the scheme based on the channel sharing ratio may be configured for determining the carrier sensing threshold for CCA. For instance, the target metric can be that in at least 30 percent of the radio frames, the channel sharing ratio of at least 0.4 is achieved.

A diversification criterion can also be used. In this criterion, the node 30 or the UE 50 can be configured with more than one scheme and/or one or more combinations of schemes for determining the carrier sensing threshold. This will ensure greater diversity, leading to better performance over time. For example, the node 30 or the UE 50 may periodically or aperiodically switch between different schemes, e.g., after every L frames. An unequal time period may also be assigned for different schemes.

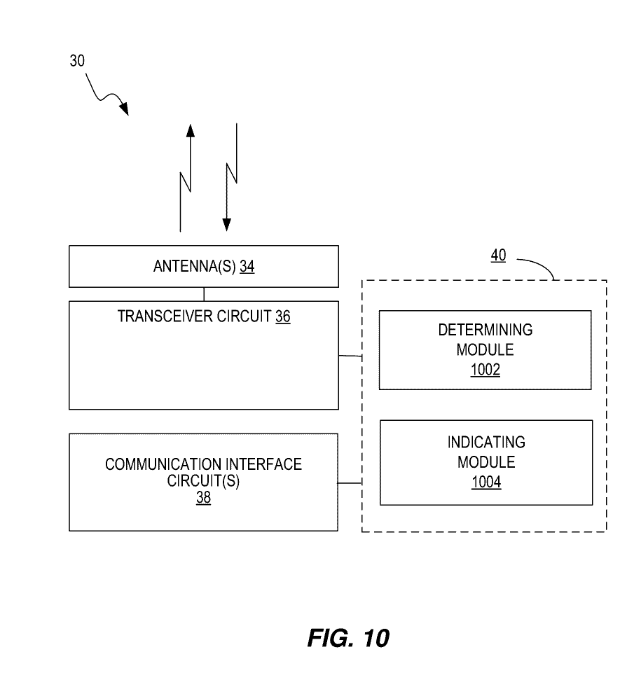

FIG. 10 illustrates an example functional module or circuit architecture as may be implemented in the network access node 30, e.g., based on the adaptive carrier sensing circuitry 40. The illustrated embodiment at least functionally includes a determining module 1002 for dynamically determining a carrier sensing threshold for determining whether a first carrier is available for use by the device, based on channel information. The embodiment also includes an indicating module 1004 for indicating an availability of the first carrier responsive to a CCA of the first carrier, based on the carrier sensing threshold.

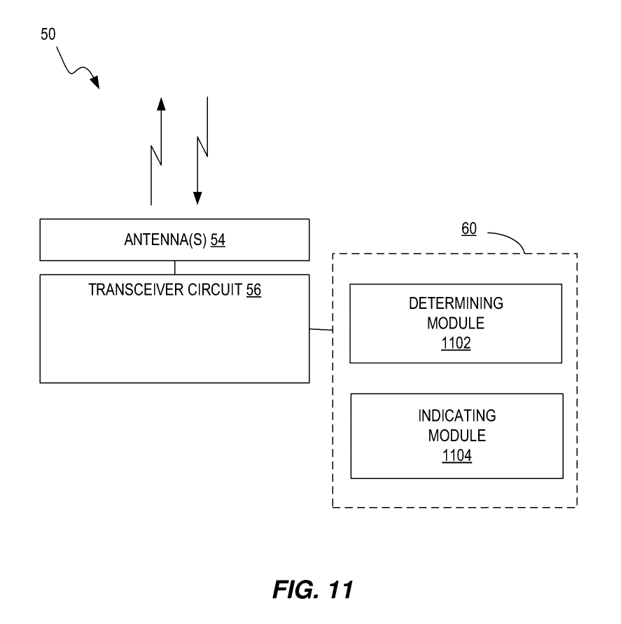

FIG. 11 illustrates an example functional module or circuit architecture as may be implemented in the user equipment 50, e.g., based on the adaptive carrier sensing circuitry 60. The illustrated embodiment at least functionally includes a determining module 1102 for dynamically determining a carrier sensing threshold for determining whether a first carrier is available for use by the device, based on channel information. The embodiment also includes an indicating module 1104 for indicating an availability of the first carrier responsive to a CCA of the first carrier, based on the carrier sensing threshold.

Dynamically determining a carrier sensing threshold enables a node or UE utilizing LAA to adapt its channel access mechanism based on its surroundings so that it benefits itself and other coexisting networks. This provides for many advantages. For example, using a dynamically determined (e.g., adapted) LAA carrier sensing threshold improves performance of LAA by giving LAA nodes or UEs appropriate channel share while also reducing hidden node issues at the LAA receivers. Using a dynamically determined LAA threshold also improves coexistence with other networks like Wi-Fi or LAA nodes belonging to other operators by being gentler to them when required and by being more aggressive when those networks have no data to transmit. The embodiments also allow the node or UE to autonomously select or be configured to use the most appropriate determining schemes out of a plurality schemes for determining the carrier sensing threshold for performing CCA. This allows the node or UE to enhance performance and allows co-existence with other nodes under different conditions or criteria.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-28. (canceled)

29. A method, in a device operating in a wireless communication network with at least a first carrier, the method comprising:
dynamically determining a carrier sensing threshold for determining whether the first carrier is available for use by the device, based on channel information; and
indicating an availability of the first carrier responsive to a clear channel assessment (CCA) of the first carrier, based on the carrier sensing threshold.

30. The method of claim 29, further comprising operating in carrier aggregation with the first carrier and at least a second carrier.

31. The method of claim 30, wherein the first carrier corresponds to an unlicensed frequency band and the second carrier corresponds to a licensed frequency band.

32. The method of claim 29, further comprising transmitting signals on the first carrier responsive to the indication of availability of the first carrier.

33. The method of claim 32, wherein dynamically determining the carrier sensing threshold comprises determining the carrier sensing threshold based on a rate of previous CCA indications of availability of the first carrier.

34. The method of claim 29, wherein the first carrier is a Licensed Assisted Access (LAA) carrier.

35. The method of claim 29, wherein dynamically determining the carrier sensing threshold comprises determining the carrier sensing threshold based on a quality of one or more signals previously detected on the first carrier.

36. The method of claim 35, wherein dynamically determining the carrier sensing threshold comprises decreasing the carrier sensing threshold responsive to a determination that the signal quality is less than a target signal quality and increasing the carrier sensing threshold responsive to a determination that the signal quality is greater than the target signal quality.

37. The method of claim 29, wherein dynamically determining the carrier sensing threshold comprises determining the carrier sensing threshold based on a channel sharing ratio of use of the first carrier by the device compared to use of the first carrier by other devices.

38. The method of claim 37, wherein dynamically determining the carrier sensing threshold comprises decreasing the carrier sensing threshold based on a channel sharing ratio reflecting less use of the first carrier by the other devices than by the device.

39. The method of claim 37, wherein dynamically determining the carrier sensing threshold comprises increasing the carrier sensing threshold based on a channel sharing ratio reflecting more use of the first carrier by the other devices than by the device.

40. The method of claim 29, wherein dynamically determining the carrier sensing threshold comprises determining the carrier sensing threshold based on a sensitivity of a receiver of the device.

41. A device configured to operate in a wireless communication network with at least a first carrier, the device comprising a processing circuit configured to:
dynamically determine a carrier sensing threshold for determining whether the first carrier is available for use by the device, based on channel information; and
indicate an availability of the first carrier responsive to a clear channel assessment (CCA) of the first carrier, based on the carrier sensing threshold.

42. The device of claim 41, wherein the processing circuit is configured to operate in carrier aggregation with the first carrier and at least a second carrier.

43. The device of claim 42, wherein the first carrier corresponds to an unlicensed frequency band and the second carrier corresponds to a licensed frequency band.

44. The device of claim 42, wherein the processing circuit is configured to transmit signals on the first carrier responsive to the indication of availability of the first carrier.

45. The device of claim 44, wherein the processing circuit is configured to dynamically determine the carrier sensing threshold based on a rate of previous CCA indications of availability of the first carrier.

46. The device of claim 41, wherein the first carrier is a Licensed Assisted Access (LAA) carrier.

47. The device of claim 41, wherein the processing circuit is configured to dynamically determine the carrier sensing threshold based on a quality of one or more signals previously detected on the first carrier.

48. The device of claim 47, wherein the processing circuit is configured to decrease the carrier sensing threshold responsive to a determination that the signal quality is less than a target signal quality and increase the carrier sensing threshold responsive to a determination that the signal quality is greater than the target signal quality.

49. The device of claim 41, wherein the processing circuit is configured to dynamically determine the carrier sensing threshold based on a channel sharing ratio of use of the first carrier by the device compared to use of the first carrier by other devices.

50. The device of claim 49, wherein the processing circuit is configured to decrease the carrier sensing threshold based on a channel sharing ratio reflecting less use of the first carrier by the other devices than by the device.

51. The device of claim 49, wherein the processing circuit is configured to increase the carrier sensing threshold based on a channel sharing ratio reflecting more use of the first carrier by the other devices than by the device.

52. The device of claim 41, wherein the processing circuit is configured to determine the carrier sensing threshold based on a sensitivity of a receiver of the device.

53. A non-transitory computer readable storage medium storing a computer program comprising program instructions that, when executed on a device configured to operate in a wireless communication network using at least a first carrier, cause the processing circuit to:
dynamically determine a carrier sensing threshold for determining whether the first carrier is available for use by the device, based on channel information; and
indicate an availability of the first carrier responsive to a clear channel assessment (CCA) of the first carrier, based on the carrier sensing threshold.
